(19) United States
(12) Patent Application Publication
(10) Pub. No.: US 2004/0245242 A1
(43) Pub. Date: Dec. 9, 2004

(54) Heat-activated electrical coupling for in situ circuit reconfiguration

(76) Inventors: Daniel J. Byrne, Fort Collins, CO (US); Amol S. Pandit, Greeley, CO (US); Mark N. Robins, Greeley, CO (US)

Correspondence Address: HEWLETT-PACKARD COMPANY, Intellectual Property Administration, P.O. Box 272400, Fort Collins, CO, 80527-2400, US

(21) Appl. No.: 10/456,223

(22) Filed: Jun. 6, 2003

(51) Int. Cl. H05B 1/02

(52) U.S. Cl. 219/517; 219/541

(57) ABSTRACT

The present invention in situ reconfigures connections within an electric circuit, such that a previously open circuit becomes a permanent in situ electrical pathway. A heat-activated electrical coupling comprises a heat-activated coupler and a heater. The heat-activated coupler comprises a preform of a material that changes a physical or electrical state in response to heat from the heater to bridge a gap between separate but adjacent ends of respective circuit traces. An in situ reconfigurable circuit comprises the heat-activated electrical coupling, a fusible link, a primary circuit and a secondary or back-up circuit. An in situ recoverable electrostatic discharge (ESD) circuit comprises the heat-activated electrical coupling, a primary ESD protection portion, and a secondary or back-up ESD protection portion. A method of in situ reconfiguring a circuit comprises creating the heat-activated electrical coupling and activating the electrical coupling with heat.

### TECHNICAL FIELD

The invention relates to electronic devices. In particular, the invention relates to electronic circuits and circuit boards used in electronic devices.

### BACKGROUND OF THE INVENTION

The complexity of modern electronic devices and systems continues to increase with each passing product cycle. Concomitant with the increases in complexity is a desire that single devices or systems be capable of providing multiple functions or be able to accommodate multiple application modalities. While complexity and functionality is on the increase, expectations regarding reliability remain constant or are also increasing with time. The apparent divergence of the trends in complexity, multi-functionality, and constant or improved reliability expectations is driving an interest in hardware reconfigurability or reprogrammability in such modern devices and system. In particular, providing an ability to reconfigure hardware to correct circuit failures or to accommodate new operational conditions for the device is of great interest to designers and manufacturers of modern devices and systems.

For example, reliability of a modern electronic device is related to reliability of the various circuits that make up the device. As the number of such circuits in the device increases, reliability of the device as a whole generally suffers. In particular, the more circuits that can fail, the lower the overall reliability of the device even if a reliability of each of the individual circuits is maintained at a constant level. In addition, protection circuits are often designed into the circuits of the device to enable the device to ‘survive’ potentially damaging events, such as an electrostatic discharge (ESD) spike, even though such a spike may disable or cause a failure in a portion of the protection circuit. As such, there is a great deal of interest in producing circuits that are inherently reliable or that can be made inherently reliable by providing a back-up circuit to replace a failed circuit in the device.

Conventionally, when a circuit in a device is damaged, fails or is otherwise disabled, the typical solution consists of either removing and replacing/repairing the circuit or scraping the device and replacing it with another functional device. For high cost and/or unique devices, scraping is often not a viable alternative. Thus, attention falls on removing and either repairing or replacing the disabled circuit.

Unfortunately, in many cases removing and replacing/repairing the disabled circuit may also be somewhat problematic. In particular, accessing disabled circuits may be relatively difficult in many small complex electronic devices. Whether the device is scraped and replaced or removal and repair/replacement of the circuit is performed, the device is generally rendered unavailable for use for a period of time. The disabled circuit and corresponding unavailable device result in device downtime and costs associated therewith.

Accordingly, it would be advantageous to have a way to repair or reconfigure a circuit in real time to avoid costly downtime for the related device. Such a real-time repairable or reconfigurable circuit would solve a long-standing need in the area of electronic devices.

### SUMMARY OF THE INVENTION

The present invention facilitates adapting or reconfiguring connections within an electric circuit. In particular, the present invention provides a means for creating in situ a new electric connection or coupling for the electric circuit. The new connection thus created may serve as a high current pathway in the electric circuit, according to the present invention. Specifically, the present invention produces an inherently low-resistance, high current capacity connection, wherein the connection is selectively established within an electric circuit incorporated in an operational device or system. Among other applications, the present invention provides an in situ means for reconfiguring a circuit and for repairing an electrostatic discharge protection circuit used to protect a circuit of an electronic device.

In an aspect of the present invention, a heat-activated in situ electrical coupling is provided. The heat-activated electrical coupling forms a new, essentially permanent, in situ electric pathway in a circuit upon activation. The heat-activated electrical coupling comprises a heat-activated coupler and a heater that provides heat to activate the heat-activated coupler. In some embodiments, the heat-activated coupler comprises an electrically conductive preform of one or both of a solder and a solder-like material that flows in response to heat to bridge a gap in the circuit between adjacent ends of respective circuit traces to form the new in situ electrical pathway. In other embodiments, the heat-activated coupler comprises a material having a heat-activated electrical conductivity change that provides an electrical connection across the gap upon heat activation to form the new in situ electrical pathway.

In another aspect of the present invention, an in situ reconfigurable circuit is provided. The reconfigurable circuit substitutes a secondary or back-up circuit in situ for a primary circuit using means for producing an open circuit and a heat-activated electrical coupling. In another aspect of the present invention, an in situ recoverable electrostatic discharge (ESD) circuit is provided. The recoverable ESD circuit employs a heat-activated electrical coupling to re-establish a back-up ESD protection capability following an ESD event that disables a primary protection portion of the ESD circuit. In yet another aspect of the present invention, a method of in situ reconfiguring a circuit is provided that in situ creates and activates a heat-activated electrical coupling.

One or more of the following features and/or advantages may be realized by the present invention. A new electrical pathway is formed in a circuit, the new pathway being essentially permanent once established. The newly formed pathway may exhibit inherently low resistance and may possess a high current carrying capacity. Furthermore, the new electrical pathway is created in situ in an operational device or system. Using the present invention, circuits may be reconfigured to change an operation of the circuit or to repair a disabled circuit or portion thereof. Certain embodiments of the present invention have other advantages in addition to and in lieu of the advantages described hereinabove. These and other features and advantages of the invention are detailed below with reference to the following drawings.

### BRIEF DESCRIPTION OF THE DRAWINGS

The various features and advantages of the present invention may be more readily understood with reference to the following detailed description taken in conjunction with the accompanying drawings, where like reference numerals designate like structural elements, and in which:

FIG. 1 illustrates a block diagram of an in situ heat-activated electric coupling according an embodiment of the present invention.

FIG. 2A illustrates a perspective view of a heat-activated electric coupling according to an embodiment of the present invention.

FIG. 2B illustrates as a cross sectional of the heat-activated electric coupling illustrated in FIG. 2A.

FIG. 2C illustrates a magnified cross sectional view of the coupling illustrated in FIG. 2B with a heater activated and showing an effect of heating on a pair of solder preforms.

FIG. 2D illustrates the magnified cross sectional view illustrated in FIG. 2C after the heater is deactivated and heat is removed showing the fused and re-solidified preforms.

FIG. 3A illustrates a perspective view of a pair of cylindrical shaped solder preforms in accordance with an embodiment of the present invention.

FIG. 3B illustrates a perspective view of a pair of preforms formed by milling or etching a gap through a middle portion of an oblate half-spheroid shaped solder preform in accordance with an embodiment of the present invention.

FIG. 4A illustrates a perspective view of an exemplary cantilevered solder preform according to an embodiment of the present invention.

FIG. 4B illustrates a perspective view of an exemplary solder preform according to an embodiment of the present invention.

FIG. 5A illustrates a perspective view of an exemplary embodiment of a heat-activated coupler having a pair of gaps according to the present invention.

FIG. 5B illustrates a perspective view of a heat-activated coupler having an interdigital or serpentine gap according to an embodiment of the present invention.

FIG. 6A illustrates cross section of an embodiment of a heat-activated electric coupling having a cover according to an embodiment of the present invention.

FIG. 6B illustrates a cross sectional view of an embodiment of a heat-activated electric coupling having an integral cover configuration according to an embodiment of the present invention.

FIG. 6C illustrates a solder preform illustrated in FIG. 6B following heat-activation according to the present invention.

FIG. 7A illustrates a perspective view of an embodiment of a heat-activated electric coupling having a solder mask prior to heat activation according to an embodiment of the present invention.

FIG. 7B illustrates the heat-activated electric coupling of FIG. 7B following heat activation in accordance with the present invention.

FIG. 8A illustrates a perspective view of an embodiment of a heat-activated coupler that employs a heat-induced conductive state change material according to an embodiment of the present invention.

FIG. 8B illustrates a cross sectional view of the heat-activated coupler illustrated in FIG. 8A in accordance with the present invention.

FIG. 9 illustrates a block diagram of a reconfigurable circuit according an embodiment of the present invention.

FIG. 10 illustrates a block diagram of a recoverable electrostatic discharge (ESD) circuit according to an embodiment of the present invention.

FIG. 11 illustrates a flow chart of a method of reconfiguring a circuit connection with a heat-activated electric coupling according to an embodiment of the present invention.

### MODES FOR CARRYING OUT THE INVENTION

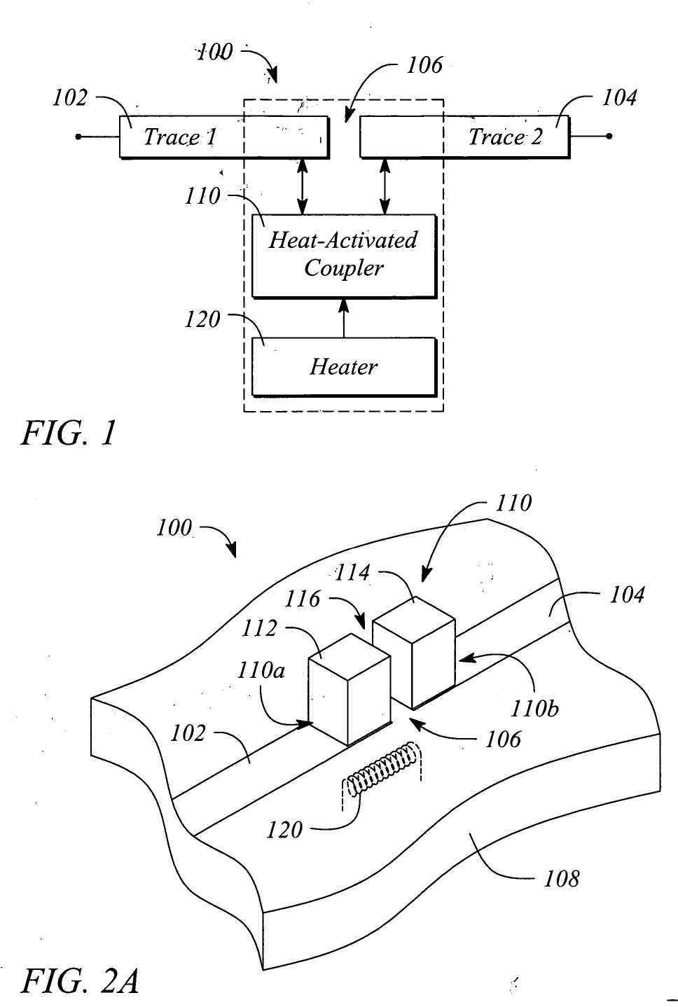

FIG. 1 illustrates a block diagram of a heat-activated electric coupling 100 according an embodiment of the present invention. The heat-activated electric coupling 100 provides an in situ, selectively initiated connection between a pair of circuit traces of an electric circuit. Specifically, the connection is formed in response to a signal applied to the heat-activated electric coupling 100. Once formed, the connection facilitates a flow of electric current between the pair of traces. Thus, the heat-activated electric coupling 100 essentially forms or creates a new electrical pathway in the electric circuit upon activation by the applied signal.

Furthermore according to the present invention, the new electrical pathway is essentially permanent and may be created in the electric circuit while the circuit is installed in an operational device or system. As such, the electrical coupling 100 may facilitate a reconfiguration of the device or system without requiring disassembly or manufacturing rework. In particular, the heat-activated electric coupling 100 according to the present invention may be used to implement in situ reconfigurable circuits and subsystems of operational devices or systems.

In some respects, the heat-activated electric coupling 100 acts in a manner similar to a switch. However unlike a switch, the connection formed by the coupling is ‘permanent’ or essentially non-reversible once activated. In addition, the coupling has a high current capability enabling the use of the electric coupling 100 in traditionally high-current applications such as, but not limited to, power supply circuits and electrostatic discharge circuits. Thus in many ways, the present invention may be considered to be an “anti-fuse” since the new electrical pathway is formed upon activation, as opposed to an existing pathway being destroyed at activation, as is the case for a conventional fuse or fusible link.

According to an embodiment of the present invention, the in situ heat-activated electric coupling 100 comprises a heat-activated coupler 110 and a heater 120. The heater 120 is adjacent to and thermally connected to the heat-activated coupler 110. The heat-activated coupler 110 is connected to a first circuit trace 102 at a first side or edge 110a of the coupler 110. A second trace 104 is connected to the heat-activated coupler 110 at a second side or edge 110b of the coupler 110. Prior to activation, the heat-activated coupler 110 electrically isolates the first circuit trace 102 from the second circuit trace 104. Following activation, the heat-activated coupler 110 electrically connects the first circuit trace 102 to the second circuit trace 104. Preferably, the heat-activated coupler 110 provides a low-resistance, high current capacity electrical connection between the first and second circuit traces 102, 104, after activation.

The heat-activated coupler 110 is activated by application of heat. The heat is applied by the heater 120 in response to an activation signal being applied to the heater 120. For example, the signal may be a voltage or a current applied to the heater 120. Preferably, there exists a heat threshold below which the heat-activated coupler 110 is not activated. When heat applied by the heater 120 exceeds the heat threshold, the heat-activated coupler 110 is activated and the electrical connection is formed.

In some embodiments, the heat-activated coupler 110 comprises a solder preform or a preform of solder-like material. By ‘preform’ it is meant that the solder or solder-like material is formed in a pre-determined shape, the shape representing a non-minimum energy configuration with respect to the solder in a melted or flowable condition. In other words, the solder preform has a shape that is generally maintained at temperatures below the heat threshold. However, at temperatures above the heat threshold, the solder preform melts or begins to flow. Once melting begins to occur, surface tension, gravity and/or other similar forces, cause the molten solder preform to change shape (e.g.. flow). The shape change of the molten solder bridges a gap 106 between respective ends of the first and second circuit traces 102, 104. When heat from the heater 120 is removed, the solder re-solidifies still bridging the gap 106. Thus, an electrical connection is formed between the circuit traces 102, 104 by the re-solidified solder.

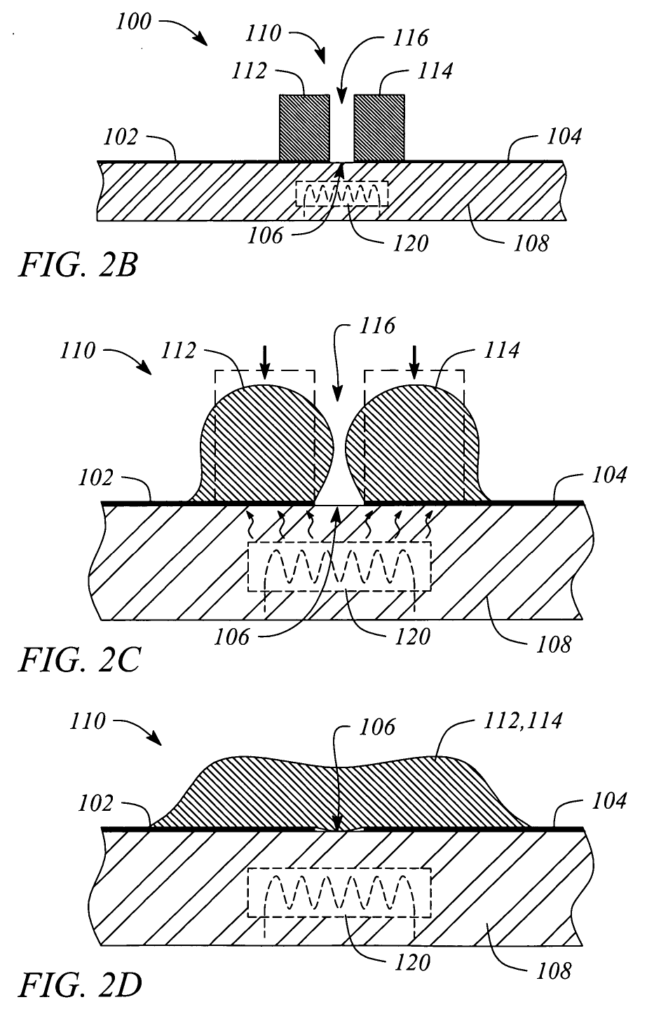

FIG. 2A illustrates a perspective view of a heat-activated electric coupling 100 according to an embodiment of the present invention. FIG. 2B illustrates as a cross sectional view of the heat-activated electric coupling 100 illustrated in FIG. 2A. As illustrated, the heat-activated coupler 110 comprises a first, block-shaped solder preform 112 and a second, block-shaped solder preform 114. The first solder preform 112 is connected to the end of the first circuit trace 102. Similarly, the second solder preform 114 is connected to an end of the second circuit trace 104. A gap 116, coincident with the gap 106 between the traces 102, 104, separates the first solder preform 112 from the second solder preform 114. As illustrated in FIGS. 2A and 2B, the heater 120 is mounted in a circuit board or substrate 108 that supports the circuit traces 102, 104.

FIG. 2C illustrates a magnified cross sectional view of the coupling illustrated in FIG. 2B with the heater 120 activated and showing an effect of heating on the pair of solder preforms 112, 114. Specifically, when sufficient heat (i.e., a heat that produces a temperature above a heat threshold or a melting temperature of the solder) is applied to the solder preforms 112, 114 by the heater 120, the solder preforms 112, 114 begin to melt. Heating by the heater 120 is indicated by wavy arrows in FIG. 2C. Preferably, the heat is localized or concentrated on the thermally connected heat-activated coupler 110.

While the solder of the preforms 112, 114 is in an essentially molten state, surface tension acting on the preforms 112, 114 causes a change in shape of the preforms 112, 114. In particular, as illustrated in FIG. 2C, adjacent sides of the preforms 112, 114, essentially bulge toward one another. In addition, the preforms 112, 114 slump or subside as indicated by the bold arrows in FIG. 2C. Slumping and bulging continues until the preforms 112, 114 touch each other. Upon touching, the preforms 112, 114 fuse together.

FIG. 2D illustrates a magnified cross sectional view illustrated in FIG. 2C after the heater 120 is deactivated and heat is removed showing the fused and re-solidified preforms 112, 114. The fused preforms 112, 114, form a new conductive electrical pathway that bridges the gap 106 between the traces 102, 104. Thus, after heat-activation using the heater 120, the heat-activated electric coupling 100 electrically connects the first circuit trace 102 to the second circuit trace 104.

The solder preforms 112, 114 described hereinabove may be realized in a variety of shapes and configurations. Common to all of the shapes and configurations is the ‘non-minimum’ energy configuration that facilitates the bridging of the gap 106 during heat activation. As used herein and described hereinabove, ‘non-minimum’ energy configuration means that when in a flowable state, the preforms 112, 114 will slump or flow under the influences of surface tension and/or other forces in such a way as to bridge the gap 106.

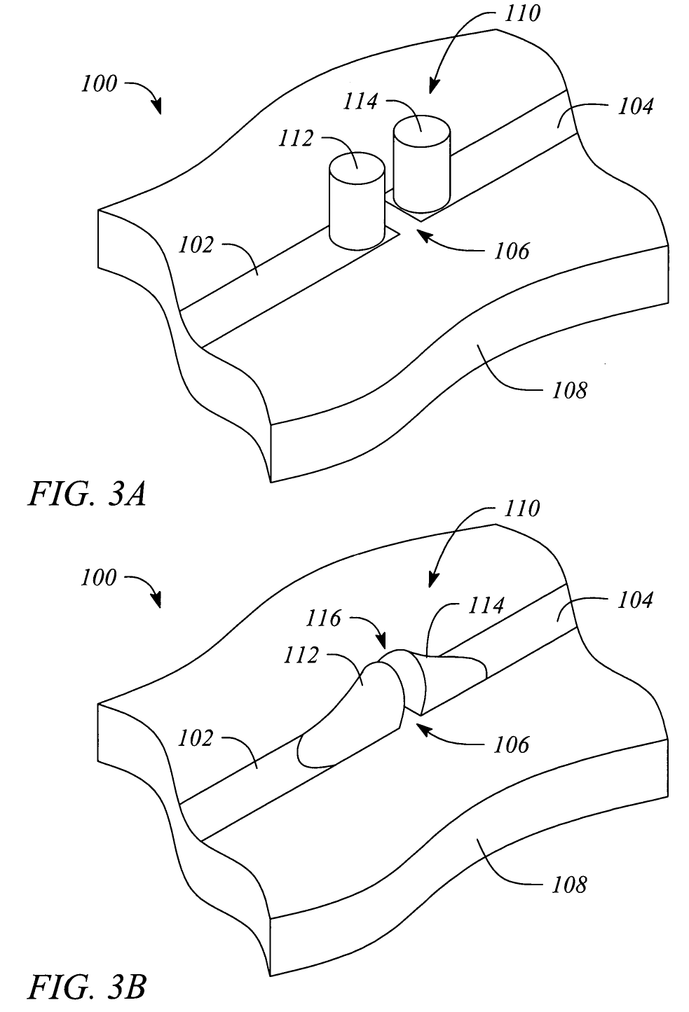

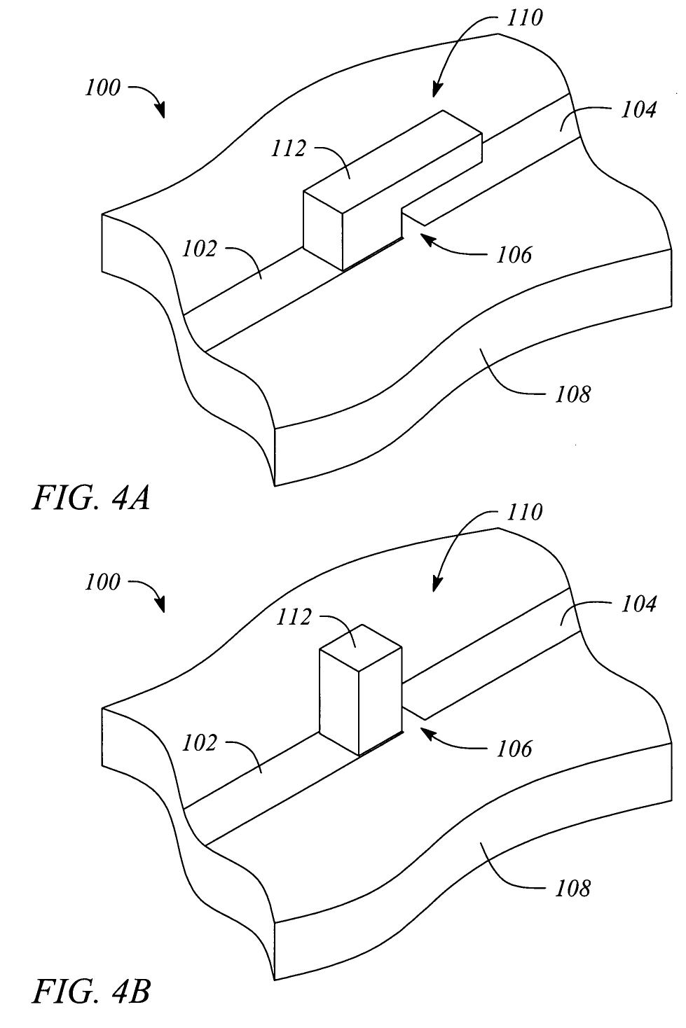

For example, FIG. 3A illustrates a perspective view of a pair of cylindrical shaped solder preforms 112, 114. In another example (not illustrated) a pyramidal or a conical shape may be used to realize the pair of solder preforms 112, 114. FIG. 3B illustrates a perspective view of a pair of preforms 112, 114 formed by milling or etching the gap 116 through a middle portion of an oblate half-spheroid shaped solder preform. In particular, the pair of preforms 112, 114 illustrated in FIG. 3B may initially bridge the gap 106 between the circuit traces 102, 104 prior to the gap 116 being milled or etched. One skilled in the art may readily devise a wide variety of additional shapes and configurations of the pair of solder preforms 112, 114, all shapes and configurations of which are within the scope of the present invention. The heater 120 located within or affixed to a bottom surface of the substrate 108 below the heat-activated coupler 110 is omitted in FIGS. 3A and 3B for clarity.

In some embodiments, a single solder preform 112 may be employed instead of a pair of preforms 112, 114 in the heat-activated coupler 110. FIG. 4A illustrates a perspective view of an exemplary cantilevered solder preform 112 according to an embodiment of the present invention. The cantilevered solder preform 112 is affixed to the end of the first circuit trace 102 and overhangs an end of the second circuit trace 104. Whether the cantilevered solder preform 112 is affixed to the first circuit trace 102 or second circuit trace 104 to overhang the other of the circuit traces is arbitrary and not a limitation herein. Application of heat by the heater 120 causes the cantilevered preform 112 to collapse effectively bridging the gap 106.

FIG. 4B illustrates another exemplary embodiment of a heat-activated coupler 110 that employs a single solder preform 112. As illustrated in FIG. 4B, a rectilinear, block shaped solder preform 112 is arbitrarily affixed to the end of the first circuit trace 102. Upon heating, the solder preform 112 slumps, collapses, and eventually bridges the gap 106 to produce a connection between the circuit traces 102, 104. An illustration of the heater 120 is omitted in FIGS. 4A and 4B for clarity.

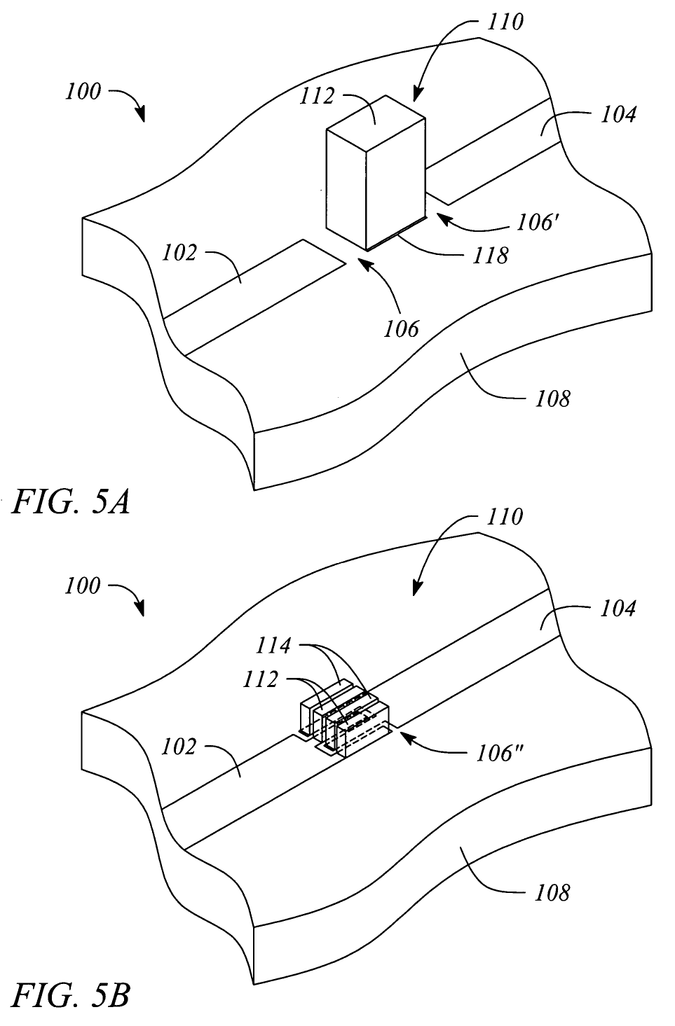

In some embodiments, a more complicated gap 106 between the traces 102, 104 may be employed. For example, a pair of gaps 106, 106′ or an interdigital gap 106″ may be used to separate the ends of the circuit traces 102, 104. FIG. 5A illustrates a perspective view of an exemplary embodiment of a heat-activated coupler 110 having a pair of gaps 106, 106′. As illustrated in FIG. 5A, the pair of gaps 106, 106′ delineate a pad 118 between respective ends of the circuit traces 102, 104. A single solder preform 112 may be affixed to the pad 118, for example. When heated, the single solder preform 112 slumps and bridges the two gaps. After heat-activation, the single solder preform 112 slumps to such an extent that both of the gaps 106, 106′ are bridged and an electrical connection is formed between the circuit traces 102, 104.

FIG. 5B illustrates a perspective view of a heat-activated coupler 110 having an interdigital or serpentine gap 106″ according to an embodiment of the present invention. As illustrated in FIG. 5B, solder preforms 112, 114 are located on fingers formed by the interdigital gap 106″. As with other embodiments of the heat-activated coupler 110, heating the preforms 112, 114 causes the preforms 112, 114 to melt and bridge across the gap 106″. The interdigital gap 106″ may provide some advantages over other gap configurations. In particular, a length of the gap 106″ is longer than most other gap configurations increasing a likelihood that the solder preforms 112, 114 will fuse along at least a portion of the gap during heat-activation. Thus, a smaller amount of solder or a smaller overall size of the preforms 112, 114 may be employed to achieve a reliable heat-activated coupler 110 in many cases by using the interdigital gap 106″.

In other applications, a means for protecting the solder and/or the ends of the traces 102, 104 from corrosion or contamination may be employed. It is well known, for example, that corrosions and/or contamination may interfere with fusing of the solder preforms 112, 114 and/or wetting of the circuit traces 102, 104 by the molten solder. Thus, in some embodiments, the heat-activated electric coupling 100 may further comprise a cover 130. In particular, the cover 130 may be positioned to protect the preforms 112, 114 of the heat-activated coupler 110 and/or the ends of the circuit traces 102, 104 from corrosion and/or contamination prior to heat-activation.

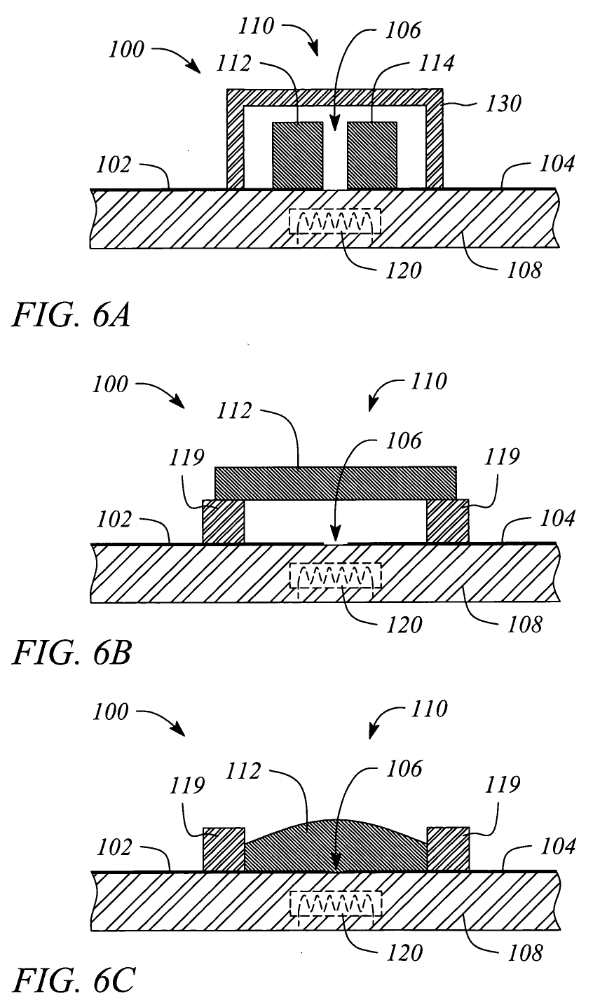

FIG. 6A illustrates a cross section of an embodiment of the heat-activated electric coupling 100 having a cover 130 according to the present invention. The cover 130 may be a cap 130 manufactured separately from the circuit board 108 that is affixed to the circuit board to protect the preforms 112, 114. In such an embodiment, the cover 130 may comprise a plastic material molded or formed into a cap. Preferably, the cover 130 is placed over the heat-activated coupler 110 and affixed to the circuit board 108 during circuit board manufacture. Alternatively, the cover 130 may be a protective coating 130 (not illustrated) that is applied to the circuit board 108 to protect the preforms 112, 114 of the heat-activated coupler 110. For example, Humiseal® or a similar material may be applied to the circuit board 108 during manufacture to protect the heat-activated coupler 110. Preferably, if a coating such as Humiseal® is employed, care is taken during application of the coating to insure that the solder preform gap 116 is not filled so that the solder preforms 112, 114 are still able to flow and bridge the gap 106 between the traces 102, 104 during heat-activation. Humiseal® is a registered trademark for resinous protective coatings for electronics applications registered to Columbia Chase Corporation, New York.

In other embodiments, a configuration of the heat-activated coupler 110 may provide integral or inherent protection, essentially eliminating a need for a separate cover 130. FIG. 6B illustrates a cross sectional view of an embodiment of the heat-activated electric coupling 100 having an integral cover configuration according to the present invention. As illustrated in FIG. 6B, a configuration of the solder preform 112 covers and protects the ends of the circuit traces 102, 104 from corrosion and/or contamination. In particular, the solder preform 112 in the form of a plate or slab is affixed to a non-conductive support 119. The non-conductive support 119 may be in the shape of a ring or be multi-sided, for example. The support 119 essentially surrounds the ends of the circuit traces 102, 104 and the gap 106 therebetween. Furthermore, the solder preform 112 affixed to the support 119 acts as a cap over the support 119 and the circuit trace 102, 104 ends. Together, the solder preform 112 and the support 119 act to cover and protect the ends of the circuit traces 102, 104 prior to heat-activation. When heat is applied by the heater 120 during heat-activation the plate-like solder preform 112 melts and collapses onto the ends of the circuit traces 102, 104 inside vertical walls of the support 119. The molten solder wets the traces and bridges the gap 106. Advantageously, the support 119 may act to contain the molten solder and insure that the gap 106 is reliably bridged. FIG. 6C illustrates the solder preform 112 illustrated in FIG. 6B following heat-activation.

As already alluded hereinabove with respect to the integral cover, at times it may be advantageous to provide a means for containing and/or directing the flow or slumping of the solder preform 112, 114 during heating. Thus in some embodiments, the heat-activated electric coupling 100 may further comprise a solder mask 140. For example, the solder mask 140 may form a ring shaped or multi-sided support, as described above with respect to FIGS. 6B and 6C.

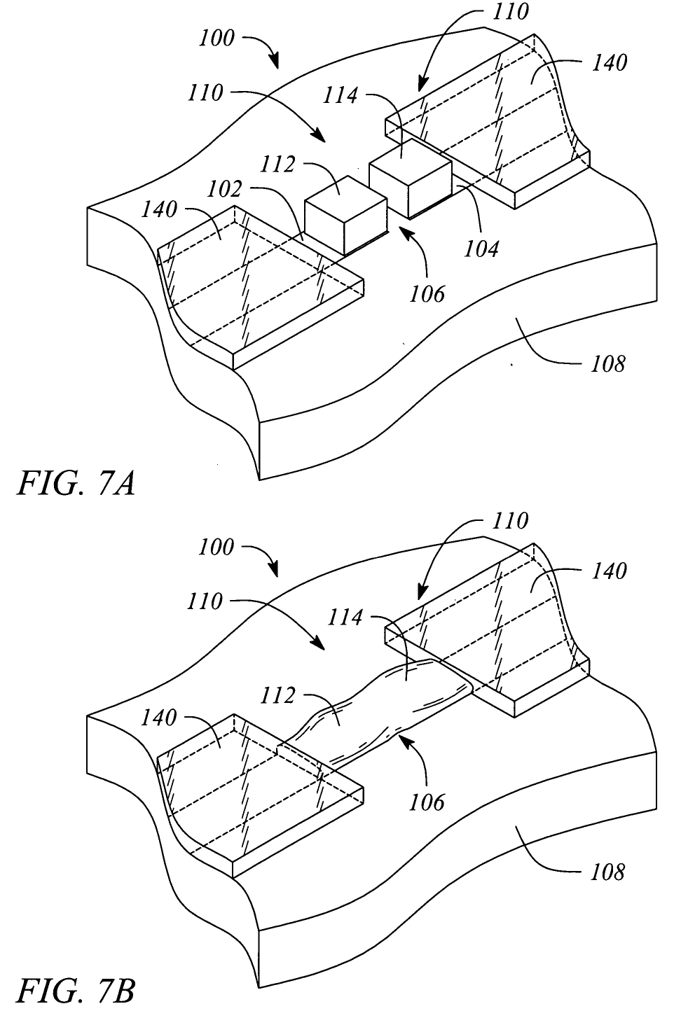

FIG. 7A illustrates a perspective view of an embodiment of a heat-activated electric coupling 100 having a solder mask 140 prior to heat activation. As illustrated, the solder mask 140 is present and located adjacent to sides of the preforms 112, 114 opposite to the gap 106. FIG. 7B illustrates the heat-activated electric coupling 100 of FIG. 7B following heat activation. The solder mask 140 prevents the melting solder of the solder preforms 112, 114 from wicking along the circuit traces 102, 104 away from the gap 106. As a result, sufficient solder is retained in a vicinity of the gap 106 to insure that the gap is bridged during heat-activation.

In all of the embodiments of the electric coupling 100 described so far hereinabove, the heat-activated coupler 110 comprised one or more preforms 112, 114 that become molten or semi-molten during heat activation. In other words, the preforms 112, 114 are rendered essentially ‘flowable’ during heat activation. A variety of solders and solder-like materials including, but not limited to, eutectic alloy solders may be used to construct such preforms 112, 114. For example, solders including, but not limited to, tin-lead (Sn—Pb), tin-lead-silver (Sn—Pb—Ag), tin-indium (Sn—In), and tin (Sn) solders may be employed. In some cases, a relatively high temperature solder, such as 95/5 tin-indium solder (i.e., 95% Sn-5% In) may be preferred since the melting temperature of such a solder is generally above a normal melting temperature of solders conventional employed to attached components to the circuit board 108. In other applications, a solder having a relatively low melting point, such as 60/40 tin-lead solder (i.e., 60% Sn-40% Pb), may be employed to minimize a melting point temperature at the heat-activated coupler 110 that must be achieved by the heater 120 during heat-activation. In addition to conventional eutectic solders, any solder-like conductive material known to melt at a temperature generally above that normally encountered during device operation that employs the heat-activated electric coupling 100 may be used. One skilled in the art may readily choose an appropriate solder or solder-like material for a given application without undue experimentation.

In other embodiments of the heat-activated electric coupling 100′, the heat-activated coupler 110′ may comprise a bridge 113 that connects ends of the circuit traces 102, 104 across the gap 106. The bridge 113 comprises a material having a heat-induced conductive state change. In other words, the material changes from a non-conductive to a conductive state upon the application of heat by the heater 120. A variety of materials exhibiting such a heat-induced conductive state change are known in the art including, but not limited to, heat-cured conductive epoxies that employ a suspension of metal powder and those that employ suspensions of metal powders in thermosetting plastics. Metal powders that are typically employed in such suspensions include, but are not limited to, gold, silver, copper, and aluminum.

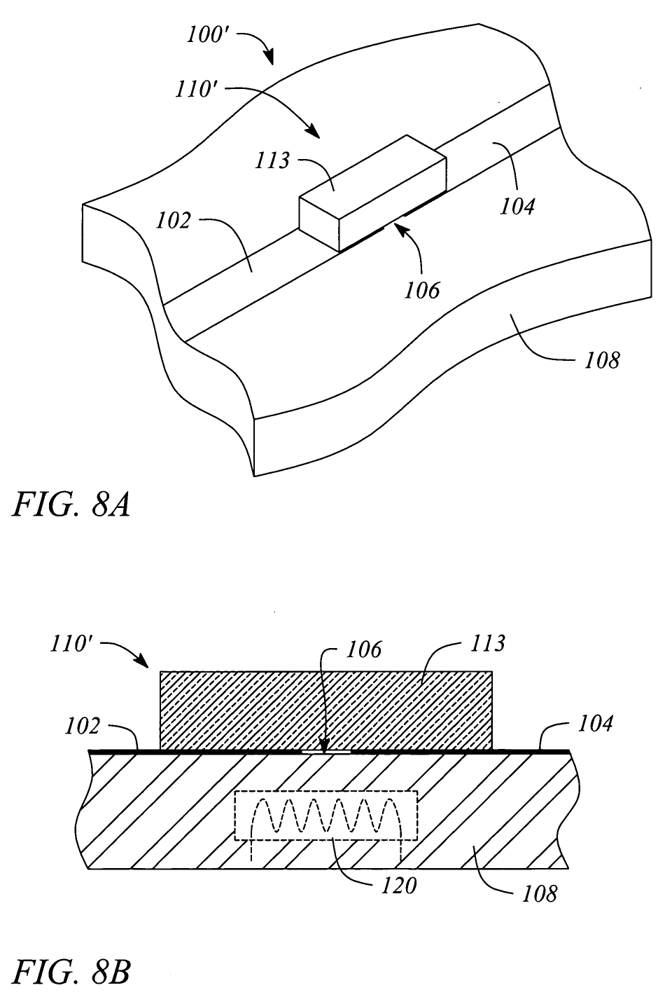

FIG. 8A illustrates a perspective view of an embodiment of a heat-activated coupler 110′ that employs a heat-induced conductive state change material bridging the circuit traces 102, 104. FIG. 8B illustrates a cross sectional view of the heat-activated coupler 110′ illustrated in FIG. 8A. The bridge 113 is connected to the circuit traces 102, 104. Since prior to heating, the material of the bridge 113 is initially non-conductive, the first trace 102 is electrically isolated from the second trace 104 by the gap 106 even though the bridge 113 is connected between the traces 102, 104. When heat is applied to the heat-activated coupler 110′, the material of the bridge 113 becomes conductive. Thus, the circuit traces 102, 104 are electrically connected to one another as a result of the application of heat by the heater 120 (not shown in FIG. 8A for clarity) to the initially non-conductive bridge 113 material.

The heater 120 may be any means for generating heat sufficient to activate the heat-activated coupler 110, 110′. In other words, any heater 120 that produces sufficient heat to melt the solder of the heat-activated coupler 110, for example, may be used with the present invention. In particular, the heater may comprise an automatic self-regulating heater technology, such as that disclosed by Carter et al., in U.S. Pat. No. 4,256,945, by Derbyshire et al. in U.S. Pat. No. 4,623,401, by Derbyshire et al. in U.S. Pat. No. 4,659,912, by Krumme in U.S. Pat. No. 4,695,713, by Carter et al. in U.S. Pat. No. 4,701,587, by Krumme, in U.S. Pat. No. 4,717,814, by Carter in U.S. Pat. No. 4,745,264, and by Henschen et al. in U.S. Pat. No. 5,010,233, all of which are incorporated by reference herein. Preferably, the heater 120 has a pair of electrical leads or contacts that may be selectively connected to a power source by an external circuit (not illustrated). Thus, when heat-activation is desired, the connection to the power source is selected, a signal is applied, and the heater 120 produces heat. Once heat-activation has been accomplished (e.g., the solder has melted) the power source (i.e., signal) may be disconnected from the heater 120.

In some embodiments, the heater 120 is integral to or embedded in the circuit board 108. For example, the heater 120 is embedded in the circuit board 108 during circuit board fabrication. Thus, the heater 120 is essentially embedded within layers that make up the circuit board 108. In other embodiments, the heater 120 is applied externally to the circuit board 108. In particular, the heater 120 may be a separate component affixed or adjacent to a backside of the circuit board 108, for example. In another example, the heater 120 may be located on or adjacent to a topside of the circuit board 108. In yet other instances, the heater 120 and solder preforms 112, 114 of the heat-activated coupler 110 may be fabricated as a unit and applied to the circuit board in a manner similar to that used to attach other circuit components. For example, the heater 120 may be incorporated within the support 119. One skilled in the art may readily devise a variety of heater 120 configurations and combined heater 120 and heat-activated coupler 110 configurations, all of which are within the scope of the present invention.

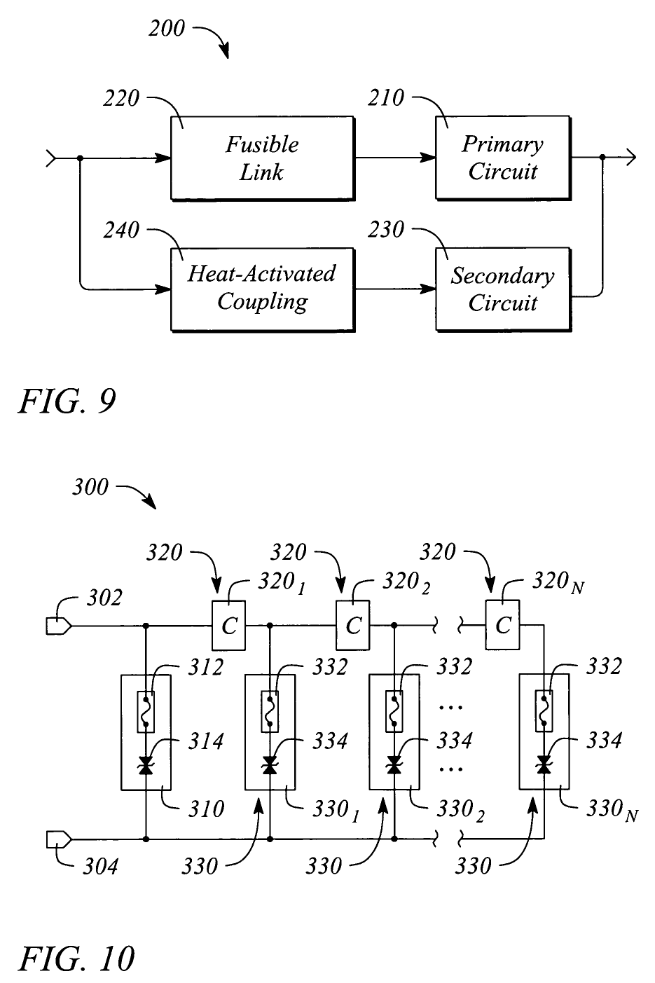

FIG. 9 illustrates a block diagram of a reconfigurable circuit 200 according an embodiment of the present invention. The reconfigurable circuit 200 enables a secondary or backup circuit to be ‘substituted’ for a primary circuit. In particular according to the present invention, the substitution may be accomplished in situ while the reconfigurable circuit 200 is installed in an operational device or system. To accomplish the substitution, the reconfigurable circuit 200 creates a new electrical pathway to the secondary circuit. The newly created pathway has a relatively low series resistance and a relatively high current capacity. Moreover, the new electrical pathway is essentially a permanent pathway, requiring no power to maintain the pathway once the pathway is created. Advantageously, the reconfigurable circuit 200 is ideal for applications wherein the secondary circuit is substituted for a damaged or disabled primary circuit and wherein the circuit connections must be capable of carrying relatively high currents and/or withstanding high voltages. For example, in a particular embodiment, the reconfigurable circuit 200 may be a portion of a power supply wherein a secondary power converter (i.e., secondary circuit) is substituted for a failed primary power converter (i.e., primary circuit).

The reconfigurable circuit 200 comprises a primary circuit 210, a fusible link 220, a secondary circuit 230, and a heat-activated electrical coupling 240. An input to the reconfigurable circuit 200 is connected to an input of the fusible link 220 and to an input of the heat-activated electrical coupling 240. An output of the fusible link 220 is connected to an input of the primary circuit 210. An output of the heat-activated coupling 240 is connected to an input to the secondary circuit 230. Both an output of the primary circuit 210 and an output of the secondary circuit 230 are connected to an output of the reconfigurable circuit 200. The reconfigurable circuit 200 may be a stand-alone circuit or may be a portion of another circuit (not illustrated).

In some embodiments, the primary circuit 210 and the secondary circuit 230 are essentially replicas of one another. For example, the primary circuit 210 and the secondary circuit 230 may be two, essentially identical, power converters of a power supply or power supply subsystem. In another example, the primary circuit 210 and the secondary circuit 230 may be a pair of essentially identical noise suppression filters on an input of a device. In such embodiments, if the primary circuit 210 were to fail or otherwise become operationally compromised, the secondary circuit 230 may be substituted for the primary circuit 210 in situ to re-establish an operational condition of the reconfigurable circuit 200 within a device or subsystem. In essence, the reconfigurable circuit 200 enables the secondary circuit 230 to assume the place of the primary circuit 210. One skilled in the art may readily recognize many devices or systems in which it is advantageous to have a secondary circuit that may be substituted for a failed or disabled primary circuit. Any such primary and second circuit pair is within the scope of the present invention.

In other embodiments, the primary circuit 210 and secondary circuit 230 are not replicas of one another but instead have relatively unique operational characteristics. In such embodiments, the reconfigurable circuit 200 facilitates changing an overall operational characteristic of a device or system employing the reconfigurable circuit 200. In particular, an operational characteristic of the device or system depends on whether the primary circuit 210 or the secondary circuit 230 is connected between the input and the output of the reconfigurable circuit 200. For example, the primary circuit 210 may be primary power converter adapted for a first set of input voltages while the secondary circuit 230 is a secondary power converter adapted for a different or second set of input voltages. In such an example, the secondary power converter 230 may be substituted for the primary power converter 210 if the second set of input voltages is expected.

The fusible link 220 is any means for permanently disconnecting or breaking a connection. In other words, the fusible link 220 provides a means for producing an open circuit between the input and the output of the fusible link 220. For example, the fusible link 220 may be a conventional fuse. The conventional fuse, when activated by being subjected to current levels that exceed a predetermined amount, permanently breaks the connection between the input of the reconfigurable circuit 200 and the input of the primary circuit 210. Thus, the primary circuit 210 is essentially removed or disabled from operation by the activation of the fusible link 220. A wide variety of fusible links, including fusible links that may be selectively activated, are known in the art. All such fusible links 220 are within the scope of the present invention.

The heat-activated electrical coupling 240 is essentially the same as the heat-activated electrical coupling 100, 100′ described hereinabove. In particular, the heat-activated electrical coupling 240 comprises a heat-activated coupler and a heater. Heat applied by the heater activates the coupler. Prior to activation, the heat-activated coupler essentially prevents a flow of current between an input and an output of the heat-activated coupling 240. When activated, the coupler provides an electrical pathway between the input and output of the heat-activated coupling 240. Thus, current may flow through the heat-activated coupling 240 once the coupling has been activated. In particular, in some embodiments, the heat-activated coupler comprises one or more solder preforms separated by a gap as described hereinabove with respect to the heat-activated coupler 110. In other embodiments, the heat-activated coupler comprises a bridge across a gap in a circuit trace, the bridge comprising a material having a heat-induced conductivity state change, as described hereinabove with respect to the heat-activated coupler 110′.

Advantageously, multiple fusible links 220 and multiple heat-activated couplings 240 may be employed in the reconfigurable circuit 200 (not illustrated). Having multiple fusible links 220 and multiple heat-activated electrical couplings 240 allows for a selection between the primary circuit 210 and the secondary circuit 230 to be made more than once. Moreover, in some embodiments, multiple secondary circuits 230 may be employed (not illustrated). When multiple secondary circuits 230 are employed, a selection of which specific secondary circuit 230 to substitute for the failed or disabled primary circuit 210 may be made depending on known capabilities of the secondary circuits 230 and a given application or use of the reconfigurable circuit 200. One skilled in the art may readily devise many such examples of the reconfigurable circuit 200 having multiple fusible links 220 and multiple heat-activated electrical couplings 240 and/or multiple secondary circuits 230, all of which are within the scope of the present invention.

FIG. 10 illustrates a block diagram of a recoverable electrostatic discharge (ESD) circuit 300 according to an embodiment of the present invention. The reconfigurable ESD circuit 300 facilitates recovering from an ESD event without requiring circuit-rework. In particular, if an ESD event disables an ESD protection portion of the recoverable ESD circuit 300, the present invention facilitates substituting a back-up ESD protection portion to replace the disabled portion.

The recoverable ESD circuit 300 comprises a primary ESD protection portion 310 connected between an input 302 and an output 304 of the recoverable ESD circuit 300. In some cases (not illustrated), the output 304 may be one or both of a power supply voltage and a ground connection of a device or system employing the recoverable ESD circuit 300. In other cases, the input and output are connected in series within a device or system employing the recoverable ESD circuit 300.

The recoverable ESD circuit 300 further comprises one or more heat-activated electrical couplings 320 and one or more back-up ESD protection portions 330. Generally, there are as many electrical coupling 320 as there are back-up ESD protection portions 330.

FIG. 10 illustrates a series connection of a plurality of heat-activated electrical couplings 320 and corresponding back-up ESD protection portions 330 according to some embodiments. In particular as illustrated in FIG. 10, a first heat-activated electrical coupling 320₁ of the plurality is connected between an input of the primary ESD protection portion 310 and an input of a first back-up ESD protection portion 330₁ of the plurality. Similarly, a second heat-activated electrical coupling 320₂ of the plurality is connected between an input of the first back-up ESD protection portion 330₁ and an input of a second back-up ESD protection portion 330₂ of the plurality. A series arrangement of any number N of heat-activated electrical couplings 320_{N} and back-up ESD protection portions 330_{N} can be realized by simply repeating the arrangement described hereinabove with respect to the first and second couplings 320₁, 320₂ and back-up ESD protection portions 330₁, 330₂. A parallel arrangement (not illustrated) of the heat-activated electrical couplings 320 and back-up ESD protection portions 330 also may be created by connecting pairs of heat-activated electrical couplings 320 and back-up ESD protection portions 330 between the input and the output of the recoverable ESD circuit 300. The parallel arrangement as well as other arrangements are within the scope of the present invention.

The primary ESD protection portion 310 and the back-up ESD protection portions 330 may be essentially the same circuit. In general, the ESD protection portions 310, 330 are circuits that either absorb a high voltage/current spike associated with an ESD event or shunt the high voltage/current spike to one or both of the power supply or ground of the device employing the ESD protection portions 310, 330. As a result, the ESD protection portions 310, 330 are circuits that act to prevent high voltage/current spikes from passing on into the device and causing damage therein.

For example as illustrated in FIG. 10, the primary ESD protection portion 310 may be a circuit comprising a fast-acting fuse 312 in series with a back-to-back Zener diode pair 314. The back-up ESD protection portion 330 may be essentially the same as the primary ESD protection portion 310. In particular, the back-up ESD protection portion 330 may comprise a fast-acting fuse 332 in series with a back-to-back Zener diode pair 334. Other examples of ESD protection circuits that may be employed as the ESD protection portions 310, 330 include, but are not limited to, ESD circuits disclosed by Reay in U.S. Pat. No. 5,485,024, by Pellegrini et al. in U.S. Pat. No. 5,510,947, by Kleveland et al. in U.S. Pat. No. 5,969,929, by Casper et al. in U.S. Pat. No. 6,040,733, and by Harrington et al. in U.S. Pat. No. 6,111,734, all of which are incorporated by reference herein in their entireties.

An ESD event of sufficient magnitude may result in an activation of the fast-acting fuse 312 of the primary ESD protection portion 310. When such an event is encountered, the fuse 312 ‘opens up’ and the primary ESD protection portion 310 is disabled. Once the primary ESD protection portion 310 is disabled, the first heat-activated coupling 320₁ may be activated to connect the first back-up ESD protection portion 330₁ and re-establish ESD protection. Thus, the ESD circuit 300 essentially ‘recovers’ from the event. Similarly, recovery from another subsequent ESD event may be accomplished by activating the second heat-activated coupling 320₂. As long as there are un-activated heat-activated couplings 320_{N} remaining, the recoverable ESD circuit 300 may similarly recover from any additional ESD events.

The heat-activated electrical coupling 320 is essentially the same as the heat-activated electrical coupling 100, 100′ described hereinabove. In particular, the heat-activated electrical coupling 320 comprises a heat-activated coupler and a heater. Heat applied by the heater activates the coupler. Prior to activation, the heat-activated coupler essentially prevents a flow of current between an input and an output of the heat-activated coupling 320. When activated, the coupler provides an electrical pathway between the input and output of the heat-activated coupling 320. Thus, current may flow through the heat-activated coupling 320 once the coupling has been activated.

According to the present invention as described hereinabove, if the primary ESD protection portion 310 is disabled for example, by an ESD event, one or more of the heat-activated electrical couplings 320 may be activated. Once activated, the heat-activated electrical coupling 320 creates a pathway from the input of the recoverable ESD circuit 300 and an input of an associated back-up ESD protection portion 330. As such, the back-up ESD protection portion 330 effectively assumes the ESD protection role of the disabled primary ESD protection portion 310. Similarly, if a particular back-up ESD protection portion 330 is disabled by a subsequent ESD event, another of the heat-activated couplings 320 may be activated to connect another of the back-up ESD protection portions 330 between the input and the output of the recoverable ESD circuit 300. Thus, through the selected activation of heat-activated electrical couplings 320, the ESD protection characteristics of the recoverable ESD circuit 300 are essentially recovered. In general, it is assumed in the discussion hereinabove that a disabled ESD protection portion 310, 330 either automatically acts as an open circuit or may be rendered an open circuit by activation of a fusible link within the ESD protection portions 310, 330.

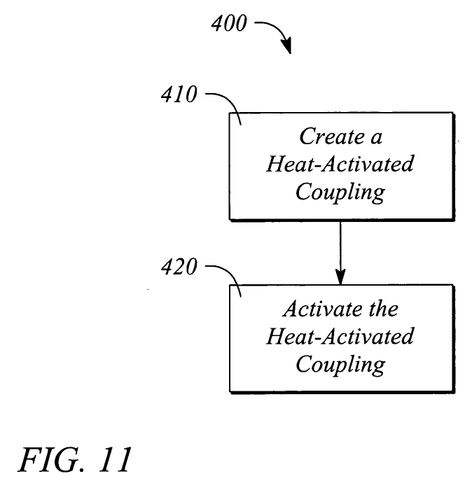

FIG. 11 illustrates a flow chart of a method 400 of in situ reconfiguring a circuit with a heat-activated electrical coupling according to an embodiment of the present invention. The method 400 of in situ reconfiguring a circuit comprises creating 410 a heat-activated electrical coupling in the circuit. In some embodiments, the heat-activated electrical coupling is created 410 by affixing one or more preforms of solder or solder-like material to one or more respective ends of circuit traces wherein the circuit trace ends are separated by a gap in the circuit. In some embodiments, the preforms may be separately manufactured and affixed to the traces using conventional circuit assembly methods. In other embodiments, the preforms may be directly formed on the traces. For example, the solder preforms may be directly formed on the traces using one or more of evaporative deposition, sputter deposition, or solder-paste screen printing, with or without a masking operation. One skilled in the art is familiar with a variety of methods for depositing solder in controlled amounts and in controlled shapes, all such method being within the scope of the present invention.

In other embodiments, the preforms may be applied in manner that initially bridges the gap between the respective circuit trace ends. Application in this case may be by either affixing a separately manufactured preform or directly depositing the preform. Following preform application, the preform is separated into two preforms by milling or etching a gap in the applied preform. The milled gap coincides with the gap between the circuit trace ends.

In yet other embodiments, the heat-activated electrical coupling is created 410 by affixing or directly depositing a bridge to the pair of circuit traces such that the bridge spans the gap between the respective ends of the pair of circuit traces. The bridge comprises a material such as, but not limited to, a heat-cured conductive epoxy that has a heat-induced conductive state change.

The method 400 of in situ reconfiguring a circuit further comprises in situ activating 420 the created heat-activated electrical coupling. In particular, the heat-activated electrical coupling is activated 420 after the circuit is installed in a device or system (i.e., in situ). In situ activating comprises applying heat to the heat-activated electrical coupling. Preferably, the heat is applied by a heater that is integral with the heat-activated electrical coupling. However, it is within the scope of the method 400 for the heater to be external to the circuit or external to the device or system in which the heat-activated electrical coupling is installed.

The heater is turned to an ON state with an application of a signal. While in the ON state, the heater generates heat essentially localized to the electrical coupling. When the signal is removed, the heater returns to an OFF state and stops producing heat. In some embodiments, the device or system can automatically generate the signal when the device or system detects an internal condition that warrants circuit reconfiguration. For example, the device or system may detect an ESD spike or that an ESD protection circuit in the device or system has malfunctioned. Upon detection of the condition, the device or system can signal the heater to in situ activate the heat-activated electrical coupling. In this example, the in situ activated electrical coupling connects an input of the malfunctioned ESD protection circuit to a backup ESD protection circuit.

In the embodiments of the heat-activated electrical coupling that uses preforms, the applied heat melts the preforms. The melted preforms bridge the gap as described hereinabove with respect to the heat-activated electric coupling 100. When the heat is removed, the preforms re-solidify to form a new, electrically conductive pathway across the gap. In the embodiments of the heat-activated coupling that uses the bridge, the applied heat causes a change in the conductivity state of the bridge as described hereinabove with respect to the heat activated coupling 100′. After applying the heat, the bridge becomes conductive, forming a new, electrically conductive pathway across the gap. In either case, the circuit is reconfigured in situ according to the method 400 by the formation of the new electrically conductive pathway.

Thus, there have been described several embodiment of a heat activated electrical coupling 100, 100′ that acts as a ‘one-time’ switch or ‘anti-fuse’ when activated, thus producing a new electric pathway within a circuit. Additionally, several embodiments of a reconfigurable circuit 200, a recoverable ESD protection circuit 300, and a method 400 of reconfiguring a circuit have been disclosed. It should be understood that the above-described embodiments are merely illustrative of some of the many specific embodiments that represent the principles of the present invention. Clearly, those skilled in the art can readily devise numerous other arrangements without departing from the scope of the present invention as defined by the following claims.

What is claimed is:

1. A heat-activated in situ electrical coupling comprising:
a heat-activated coupler that forms an in situ new electrical pathway in a circuit upon activation; and
a heater that provides heat to activate the heat-activated coupler.

2. The heat-activated in situ electrical coupling of claim 1, wherein the electrical pathway is an electrical connection that bridges a gap between adjacent ends of at least two respective circuit traces, the electrical pathway being nonexistent prior to heat activation and essentially permanent after heat activation.

3. The heat-activated in situ electrical coupling of claim 1, wherein the heat-activated coupler comprises an electrically conductive preform of one or both of a solder and a solder-like material that flows in response to heat, the flowed preform bridging a gap in the circuit between adjacent ends of respective circuit traces to form the electrical pathway.

4. The heat-activated in situ electrical coupling of claim 1, wherein the heat-activated coupler comprises a preform of a material that changes from an electrically nonconductive state to an electrically conductive state with an application of heat, the preform bridging a gap in the circuit between adjacent ends of respective circuit traces, the preform providing an electrical connection across the gap upon heat activation to form the electrical pathway.

5. The heat-activated electrical coupling of claim 1, wherein the heater is integral to the circuit, the heater providing localized heat to the heat-activated coupler, and wherein the heater is activated by one or both of a signal generated by the circuit and a signal generated by a device or system that incorporates the circuit.

6. An in situ reconfigurable circuit comprising:
means for producing an open circuit having an input connected to an input of the reconfigurable circuit;
a primary circuit having an input connected to an output of the means for producing an open circuit, and an output connected to an output of the reconfigurable circuit;
a heat-activated electrical coupling having an input connected to the reconfigurable circuit input; and
a secondary circuit having an input connected to an output of the heat-activated electrical coupling and an output connected to the reconfigurable circuit output,
wherein the electrical coupling forms a new in situ electric pathway between the reconfigurable circuit input and the secondary circuit input upon activation by heat when an open circuit is produced by the means for producing.

7. The in situ reconfigurable circuit of claim 6, wherein the secondary circuit is a replica of the primary circuit, such that the secondary circuit substitutes for the primary circuit in situ in case of failure or disablement of the primary circuit.

8. The in situ reconfigurable circuit of claim 6, wherein the secondary circuit provides a different operational characteristic relative to an operational characteristic of the primary circuit, such that the secondary circuit substitutes the different operational characteristic in situ when the primary circuit is disabled.

9. The in situ reconfigurable circuit of claim 6, wherein the means for producing an open circuit comprises a fusible link that permanently disconnects a connection between the reconfigurable circuit input and the primary circuit input when the fusible link is activated.

10. The in situ reconfigurable circuit of claim 6, wherein the means for producing an open circuit is selectively activated to provide a permanent disconnect between the reconfigurable circuit input and the primary circuit input.

11. The in situ reconfigurable circuit of claim 6, wherein the heat-activated electrical coupling electrically disconnects the reconfigurable circuit input from the secondary circuit input prior to heat activation, and wherein the heat-activated electrical coupling in situ electrically connects the reconfigurable circuit input to the secondary circuit input after heat activation.

12. The in situ reconfigurable circuit of claim 11, wherein the heat-activated electrical coupling comprises a heat-activated coupler and a heater, the heat-activated coupler comprising an electrically conductive preform of one or both of a solder and a solder-like material that flows in response to heat, the heater providing localized heat to flow or activate the preform, the heat activated preform bridging a gap between adjacent ends of respective circuit traces to form the in situ electrical pathway that connects the reconfigurable circuit input and the secondary circuit input.

13. The in situ reconfigurable circuit of claim 11, wherein the heat-activated electrical coupling comprises a heat-activated coupler and a heater, the heat-activated coupler comprising a preform of a material that changes from an electrically nonconductive state to an electrically conductive state with an application of heat, the heater providing localized heat to activate the preform, the preform bridging a gap between adjacent ends of respective circuit traces, the preform forming the in situ electrical pathway that connects the reconfigurable circuit input and the secondary circuit input upon activation with heat.

14. An in situ recoverable electrostatic discharge (ESD) circuit comprising:
a primary ESD protection portion connected between an input and an output of the recoverable ESD circuit;
a secondary ESD protection portion connected between the input and the output of the recoverable ESD circuit; and
a heat-activated electrical coupling connected between an input of the primary ESD protection portion and an input of the secondary ESD protection portion, the heat-activated electrical coupling providing an open circuit between the recoverable ESD circuit input and the secondary ESD protection portion input until the electrical coupling is activated by heat to in situ close or short the open circuit.

15. The in situ recoverable ESD circuit of claim 14, wherein the heat-activated electrical coupling comprises a heat-activated coupler and a heater, the heat-activated coupler comprises a preform on one or both adjacent ends of respective circuit traces that are physically separated by a gap, the heater providing localized heat to the coupler, the localized heat changes a state of the preform such that the gap is electrically bridged and the circuit traces are electrically connected.

16. The in situ recoverable ESD circuit of claim 15, wherein the preform comprises a solder or solder-like material that flows in response to heat, the localized heat changing the state of the preform from a solid state to a liquid state, such that the solder flows to bridge the gap and resolidifies when the localized heat is removed.

17. The in situ recoverable ESD circuit of claim 15, wherein the preform comprises a material that changes a conductivity state in response to heat from an electrically nonconductive state to an electrically conductive state, the preform physically bridging the gap prior to being activated by the heater, the preform both physically and electrically bridging the gap after being activated by the heater.

18. The in situ recoverable ESD circuit of claim 14, wherein the primary ESD protection portion comprises a fast-acting fuse, and a back-to-back Zener diode pair, the fuse being connected in series with the diode pair.

19. The in situ recoverable ESD circuit of claim 14, wherein the primary ESD protection portion and the secondary ESD protection portion are similar, the secondary ESD protection portion providing in situ back-up circuit protection when the primary ESD protection portion fails or is disabled, the heat-activated electrical coupling being activated when the primary ESD protection portion fails or is disabled.

20. The in situ recoverable ESD circuit of claim 14, wherein the secondary ESD protection portion is a member of a plurality of secondary ESD protection portions that are each disconnected from the recoverable ESD circuit input by a different corresponding heat-activated electrical coupling, the plurality providing successive in situ back-up ESD protection to the recoverable ESD circuit when a preceding secondary ESD protection portion of the plurality fails or is disabled, the corresponding electrical coupling being selectively heat activated, such that each secondary protection portion of the plurality in turn separately assumes an ESD protection role of the primary ESD protection portion.

21. A method of in situ reconfiguring a circuit comprising:
creating an electrical coupling that is heat-activatable in the circuit, the electrical coupling having an electrical disconnect or open in the circuit before heat activation, the electrical coupling in situ converting the electrical disconnect to an electrical pathway or short in the circuit after heat activation; and
in situ heat activating the created electrical coupling.

22. The method of in situ reconfiguring a circuit of claim 21, wherein the electrical coupling is created comprising applying a preform of a material to one or both of adjacent ends of respective circuit traces, the ends being separated by a gap, the preform being a material that changes a state when activated by heat, such that the gap is electrically bridged.

23. The method of in situ reconfiguring a circuit of claim 21, further comprising installing the circuit in a device or system prior to in situ heat activation.

24. The method of in situ reconfiguring a circuit of claim 23, wherein the circuit is a recoverable ESD protection circuit that provides back-up ESD protection to the device or system.
